(19) United States
(12) Patent Application Publication
(10) Pub. No.: US 2004/0205243 A1
(43) Pub. Date: Oct. 14, 2004

(54) System and a method for managing digital identities

(76) Inventors: Hans Hurvig, Copenhagen O (DK); Nikolaj Nyholm, Copenhagen V (DK)

Correspondence Address: JACOBSON HOLMAN PLLC, 400 SEVENTH STREET N.W., SUITE 600, WASHINGTON, DC, 20004, US

(21) Appl. No.: 10/469,542

(22) PCT Filed: Mar. 6, 2002
(86) PCT No.: PCT/DK02/00141

Related U.S. Application Data
(60) Provisional application No. 60/283,325, filed on Apr. 13, 2001.

(30) Foreign Application Priority Data
Mar. 9, 2001 (DK) PA 2001 00401

(51) Int. Cl. G06F 15/16

(52) U.S. Cl. 709/245

(57) ABSTRACT

The present invention relates to a system and a method for managing identities. A system is described for managing individual identities of persons or other entities interacting on a network of clients and servers, where the system comprises one or more identity servers or sites, with the identity servers or sites storing a number of identities, each identity representing identity information data of an individual person or entity, each identity having at least part of said information data being structured as a number of sets of data with at least part of said sets of data having one or more corresponding access rules selected from a plurality of different access rules. Here, the access rules of a given identity may be enforced by the identity server or site storing said given identity or by a server communicating with said identity server or site. The system of the present invention may further comprise one or more name servers constituting a namespace, where the name servers store name strings and addresses of identity servers and/or identity sites corresponding to each stored identity, said name servers thereby providing a mapping from the name strings to the corresponding identity servers or sites. The name servers tie together the identity servers or sites into a global network, creating a shared infrastructure for a variety of identity-related services and functions. The identity servers or sites are preferably self-contained, but cooperate in order to provide a coherent infrastructure, in particular by dividing between them the responsibility for authenticating identity owners.

### FIELD OF THE INVENTION

The present invention relates to a system and a method for managing identities. More specifically the invention relates to a system of identity servers and name servers connected to a common network such as to the Internet, wherein an identity server stores identity information which can be accessed by a user in accordance with corresponding access rules.

### BACKGROUND OF THE INVENTION

Many functions and applications of the Internet have an inherent notion of identity built in to them, but these notions tend to be of an ad-hoc nature. As a result the notion of identity is very fragmented, and spread out across these functions and applications in a non-related manner.

These notions of identity can be broadly classified into three categories.

The first category includes the various ways of addressing entities, in particular persons. The typical person has many unrelated addresses: the postal address of his home, one or more telephone numbers, email addresses, instant-messaging tags, and so on. These are all ways in which others can get in touch with the person in question, or in short, the way that person is addressed. These addresses are completely unrelated, however, and each depends on a particular mode of communication. Knowing an email address, for instance, gives no clue to the postal address.

The second category includes the various instances of personal data that get created throughout the Internet. Typically, when visiting a merchant or service site on the net, they will ask you to create an account, which means providing a multitude of information about one self, which is then stored at the site. It is a hassle having to provide this information repeatedly. In return the user gets yet another username and password in order to gain access to the account in the future. Since each site has its own rules and its own name space, all these usernames and passwords tend to be somewhat unrelated and very difficult to manage and remember for the user.

Also, the account data will become out of date as soon as the personal information changes, such as a change of email address or postal address.

The third category includes the different types of information that is primarily relevant to the owner himself, such as an address book, financial statements, a calendar, and so on. This data tend to be tied to particular access devices such as a home computer, a computer at work, a portable computer, a personal digital assistant, a mobile telephone, and so on. Each device tends to have its own subset of this information, in effect having its own snap-shot of the owner's personal identity. It is a permanent hassle keeping all these snap-shots synchronized and up-to-date.

The three categories can also be thought of as relating to the grammatical notions of 1^{st}, 2^{nd}, and 3^{rd} person, that is, “I”, “you”, and “them”. Addressing relates to “you”, the persons that know the owner and want to communicate with him. Account information relates to “them”, those the owner wants to introduce himself to and who want to know various information about the owner. And the personal category relates to “I”, the information that is only relevant to the owner, or indeed of a private nature.

It is a goal of the present invention to provide an infrastructure that addresses these diverse areas, and which allows for a distributed family of identity servers that can be spread though-out the Internet.

This is in very stark contrast to most present initiatives on the Internet, which are with few exceptions “site-based”, that is, based around a single web-site with a single web-site address (URL, Uniform Resource Locator). Each site-based solution is typically to a large extent proprietary, and cannot interoperate with other services.

More fundamentally, any site-based approach requires that any user of the service knows where it is hosted. So, for instance, to schedule an appointment in another person's calendar, I need to know not only the identity of that person, but also where the calendar is hosted. The present invention inverts this relationship, so that I—or my identity—go directly to the other person's identity, at which point it is simple to chose the application, namely his calendar.

A system, which can be distributed, also has great benefits in terms of scalability and robustness. There are currently more than 500,000,000 people with access to the Internet, and that number may eventually grow to more than 5,000,000,000. It is not realistic to provide a mission-critical service to that number of persons from a single site.

More fundamentally, apart from the technical infrastructure, the trustworthiness of the infrastructure must also be carried by multiple entities. Identity related services are rather close to the personal ‘sphere’, and different persons will want different providers of these services. It is for instance absurd to think that every inhabitant of France or China would want—or even allow—storing of their personal data on a facility in the USA. Rather, they would want these services provided by local providers, and preferably by established companies who they have reason to trust as worthy custodians of their personal data.

All this points to a distributed solution, where the identity related services are provided by a network of locally operated facilities, which interoperate to create the desired services. This ensures both scalability and end-user acceptance, and also ensures that there are multiple brands and multiple beneficiaries in operating the infra-structure, something that is also counter to the site-based approach.

There currently exist various attempts to address some of the areas addressed by the present invention.

At the most basic level, a personal operating system like Windows 2000 provides a very strong platform for personal information management. But even though the Windows 2000 proprietary ‘domain’ system is hooked up to the DNS, it does not give users an identity beyond the local site. And by its nature it is not device independent nor always-accessible, it doesn't function as a universal address, and it doesn't function as a universal account like the present invention does.

As for functionality available on the Internet, one example is the various ‘personalisation’ sites available, for instance Novell's www.digitalme.com. This allows the user to manage personal data and provide it to friends, and also has a calendar and so on. However, these sites all have their own non-global name space and can therefore not interoperate in a distributed fashion. Their functionality is also rather limited, and they do not function as a universal address or universal account name.

Many of these shortcomings arise from them being site-based, tied to a particular Uniform Resource Locator, URL, and having their own local notion of an account.

An example resembling the universal account is Microsoft's www.passport.com. As the name implies, it provides each user with a ‘passport’ that contains information such as shipping address and credit card numbers. This can be provided to enabled merchant sites to facilitate electronic purchases with relative ease. Passports do not function as a repository useful to the owner himself, and do not function as an address usable to get in touch with the owner. The system is also site-based, since all interaction and authentication is done through the explicitly named passport site. This prevents it from scaling, and more fundamentally does not enable a distribution of trust for those users who may be uncomfortable with letting this particular company host their private data.

Indeed, almost all activity on the Internet is site-based, with just two glaring exceptions: email and the world-wide-web itself.

Email is an extremely useful mechanism, brought about in a truly distributed fashion by means of local email servers hosting electronic mailboxes, all interacting using the SMTP protocol. But the functionality of this system is extremely limited: it can be used only to push messages towards recipients. It cannot be used for other modes of communication, it does not provide for any kind of personal information management, and it cannot be used in an account-like fashion (though email addresses are globally unique, and therefore often are used as the username on site-based account management systems).

Finally, the world-wide-web itself, which is extremely distributed using the HTTP protocol. Indeed, the initial interface to the identities of the present invention will be through www browsers, though this is just the current most practical interface to the underlying identity infrastructure.

With a browser-based interface, an identity can be seen as a very sophisticated ‘home’ page for the owner. One that doesn't simply contain unstructured content to be rendered for human eyes, but one with structured content allowing it to be an active participant in online activity. A regular home page cannot distinguish visitors, granting them graduated access to the information based on their identity. Nor is it able to interact with communications devices, providing a universal address, nor with other sites and services, providing a universal account.

The present invention can be seen as the third major class of distributed server-based functionality available on the Internet, where the first was email, and the second was the www. It provides a solution, which allows a whole range of new applications and functionality on the Internet, by providing a global and shared notion of identity across all countries and all application categories. As an example, the emerging peer-to-peer initiatives may need such a shared notion of identity in order to create interoperability across the boundaries created by each proprietary solution.

### SUMMARY OF THE INVENTION

The present invention relates to management of information related to the identity of various entities, typically persons. It may comprise a system of identity servers, which may be distributed throughout a network like the Internet, and which may create coherent online identities for each of a multitude of persons or entities. The system may be based on globally unique name strings, such as those that can be reserved through the Internet's Domain Name System. This name space may provide the backbone of an infrastructure, directing access to the appropriate identity server for each name string, such as a personal domain name, PDN.

The identity servers may support management of private information in a device-and location-independent fashion, which may comprise:

granting selective access to the private information to a multitude of other entities on the Internet, supporting unified communication based on the personal domain name as a universal address, and enabling a single sign-on to the Internet itself by using the personal domain name as a globally unique account name.

According to a first aspect of the present invention there is provided a system for managing individual identities of persons or other entities interacting on a network of clients and servers, said system comprising one or more identity servers or sites, said identity servers or sites storing a number of identities, each identity representing identity information data of an individual person or entity, each identity having at least part of said information data being structured as a number of sets of data with at least part of said sets of data having one or more corresponding access rules selected from a plurality of different access rules. Here, it is preferred that said access rules of a given identity are being enforced by the identity server or site storing said given identity or by a server communicating with said identity server or site.

It is preferred that the system of the present invention further comprises one or more name servers constituting a namespace, with said name servers storing name strings and addresses of identity servers and/or identity sites corresponding to each stored identity, said name servers thereby providing a mapping from the name strings to the corresponding identity servers or sites.

It should be understood that when using the term “identity server” in the description of the present invention, this term should be understood as an identity host, which may comprise one or more computers and/or servers, and which is capable of performing the jobs of an identity server. Such an identity host may be an identity site, where an identity server is connected to or communicating with a directory server. Here, the directory server may store the identities and/or identity information. Thus, the term “identity server” may also cover the meaning of the term “identity site”, and an identity server may include the means for storing the identity and/or the identity information, and the identity server may include the means for implementing the various identity services and applications, such as enforcing access rules. However, the access rules may also be-enforced by a computer or server communicating with the identity site or identity server.

According to an embodiment of the invention, the access rules may be selected from a plurality of access rules, and the data sets of a stored identity may have two, three, four or even more different access rules. Thus, a stored identity may comprise a set of data having at least two different access rules. The present invention also covers an embodiment wherein a stored identity may comprise at least two sets of data, wherein one of said sets of data may have at least one corresponding access rule being different to the corresponding access rule(s) of the other sets of data. It is also within an embodiment of the present invention that the data structure of a stored identity comprises at least three sets of data, and wherein each of two of said sets of data has at least one corresponding access rule being different to the corresponding access rule(s) of the other sets of data.

It is preferred that the plurality of access rules comprises access rules representing different levels or categories of authentication of a person, an entity and/or server site requesting access to a set of data of a stored identity. Thus, an access rule may be given or identified by an access category. Here, an access category may represent one of the categories: public, friend, merchant and/or private.

According to an embodiment of the invention, a stored identity may comprise a set of data having a corresponding access rule holding information of a list of a selected number of persons, entities and/or server sites being allowed access via said access rule to the information of said set of data. Here, the access rule may just be that a person, entity or server requesting access to a set of data is being part of said list. Furthermore, the access rule may require the requester to be able to verify that the requester is who he claims to be.

It is preferred that the persons, entities and/or server sites being allowed access to information of a stored identity are represented by corresponding Personal Domain Names, PDNs, and/or Uniform Resource Locators, URLs. It is also preferred that at least part or all of the sets of data of a stored identity are items. Here, the sets of data or items may be represented in an SQL database, and the sets of data or items may be represented as an XML structure.

When an access rule is given by an access category, the access category may be organised in an access category field of the corresponding set of data or item. It is also within the present invention that the identity information data of a set of data or an item may be organised in a type field and/or a value field.

In order to obtain a distributed network of identity servers or sites according to an embodiment of the present invention, it is preferred that the system comprises a plurality of identity servers or sites.

It should be understood that the different access rules may allow for a different number or type of requesters to obtain access to information of a stored identity. Thus, it is within the present invention that the plurality of different access rules comprises an access rule allowing an identity server or site to grant any non-authenticated person and/or entity access to a corresponding set of data.

It is also within the present invention that the plurality of different access rules comprises one or more access rules allowing an identity server to grant only users being authenticated according to a defined authentication process access to the set(s) of data corresponding to the access rule(s). Here, the defined authentication process may comprise a verification of the authenticity of the user. Thus, an identity server or site hosting a stored identity having a so-called private set of data may be adapted to only grant access to said private set of data to the owner of said stored identity upon authentication of the owner towards the hosting identity server or site. Here, the authentication may be performed via a client device, said client device thereby being granted access to the private set of data. In a preferred embodiment the client device is granted access to the private set of data within a limited time after the authentication.

The present invention also covers embodiments, wherein at least part of the network servers are adapted to communicate or interact with an identity server or site storing an identity having an owner, so that when the owner of the stored identity has been authenticated towards the hosting identity server or site, said part of the network servers can perform a verification of the authentication of the identity owner by communicating or interacting with the hosting identity server or site. Here, the servers being adapted for performing said verification may comprise one or more identity servers and/or one or more merchant servers. Thus, the authenticated identity owner can be granted access to one or more sets of data stored or hosted at a server having performed said verification, where said one or more sets of data may have a corresponding access rule requiring such a verification. Here, the identity owner can be granted access to one or more sets of data of an identity hosted at an identity server or site having performed said verification. It is also within the present invention that the identity owner can be granted access to one or more sets of data stored or hosted at a merchant server upon said verification, such as a set of data comprising an account of the identity owner.

It is also within the present invention to cover embodiments, wherein one or more network servers are adapted to be authenticated towards an identity server or site hosting an identity, said servers thereby being granted access to one or more sets of data of said identity, said set(s) of data having access rules being fulfilled by said authentication.

In a preferred embodiment, a network server is adapted to be authenticated towards an identity server or site hosting one or more identities, where said network server when being authenticated may request access to information from an identity having an owner and stored at said hosting identity server or site, which information has not yet being given an access rule allowing access to the authenticated server, said hosting identity server or site being adapted to forward a request to the identity owner to temporarily or permanently grant access to the information to the authenticated server. Here, the request for granting access to the authenticated server may be forwarded to a client device being used by the identity owner. Preferably, the identity owner is authenticated towards said hosting identity server or site via said client device.

When a network server or a merchant server is authenticating itself towards the hosting identity server or site, said authentication may be performed by means of an X509 certificate and using a SSL protocol.

According to a preferred embodiment of the present invention, a communication from a client device or server to an identity server or site storing a given identity may be established by forwarding the name string of the given identity from the client device or server into the namespace, said name string being received by a name server hosting said name string and hosting the address of the identity server or site storing the given identity, said address of the identity server or site being forwarded via the hosting name server to said client device or server wishing to communicate with the identity server or site storing the given identity.

It should be understood that according to the present invention an identity server or site may be adapted to forward one or more sets of data of a stored identity to a client device or server being granted access to said one or more sets of data.

It is also within the present invention that an identity server or site storing an identity may be adapted to receive a message to the owner of the stored identity and to forward said message to a client device or server being used by the identity owner.

In a preferred embodiment of the invention, the owner of a stored identity is allowed to change the information of said identity or to store information at said identity upon authentication of the owner towards the hosting identity server or site. Here, the authentication may be performed via a client device, said client device thereby being granted access to the identity of the owner. Preferably, the client device may be granted access to the owned identity within a limited time after the authentication.

According to a preferred embodiment of the invention, the name string corresponding to a stored identity may act as a global address. It is also within the present invention that the name servers function according to the Domain Name System, DNS, of the Internet. Here, a name string may be a personal domain name, PDN, reserved within the Domain Name System, DNS, so as to make it distinguishable from all other name strings reserved within the Domain Name System.

It has already been mentioned that the access rules may comprise an authentication process. Thus, it is within an embodiment of the invention that the plurality of access rules includes an access rule being at least partly fulfilled by an authentication process. Here, the authentication process may comprise the provision of a password, and/or the provision of a smart card. The authentication of an identity owner towards a server hosting the owned identity may be performed in relation to the corresponding name string of the identity.

It is preferred that the access rules of a given identity are specified by the owner of said given identity. It is also preferred that the amount of identity information of a given identity, which can be accessed via a corresponding access rule, is specified by the owner of said given identity.

Preferably, access to information or sets of data of a stored identity can be requested from all or at least part of the client devices of the network and/or all or at least part of the servers or server devices of the network.

When an owner of a stored identity has been authenticated towards the hosting identity server or site, the hosting identity server may forward a token for later verification to the client device from which the owner is communicating with the hosting identity server or site. Here, the verification token or a token derived from said verification token may be forwarded from the owners client device to other identity servers or network servers, whereby said other identity servers or network servers may use the obtained verification token or derived for having the hosting identity server verifying that the owner has been properly authenticated. The verification token or derived token may have the form of a unique and/or unpredictable number or bit-string.

When having a distributed network of identity servers or sites according to the present invention, these identity servers or sites may be managed on a corporate, sub-national, national or regional level, and inter-operated by means of common protocols.

The present invention also covers embodiments wherein the network of clients or servers is a national, a regional or a global network.

According to an embodiment of the present invention the identity representing data of an owner may be established by the following steps:

registering a name string of the owner within the name space,

creating an identity server account with a host provider, whereby an identity corresponding to the name string of the owner is obtained at a hosting identity server,

making the name servers map the registered name string to the address of the identity server hosting the identity of the owner, and

having the owner logging into the identity and entering sets of data and/or access rights or rules.

According to a second aspect of the present invention there is provided a system for managing individual identities of persons or other entities interacting on a network of clients and servers, said system comprising one or more identity servers or sites, said identity servers or sites storing a number of identities, each identity representing identity information data of an individual person or entity, each identity having at least part of said information data being structured as a set of data having at least one access rule. Here, it is preferred that said access rule of a given identity is enforced by the identity server or site storing said given identity or by a server communicating with said identity server or site. It is preferred that the at least one access rule comprises or requires an authentication process and/or a verification of the authenticity of a user requesting access to the corresponding data.

In an embodiment according to the second aspect of the present invention, at least part of the network servers are adapted to communicate or interact with an identity server or site storing an identity having an owner, so that when the owner of the stored identity has been authenticated towards the hosting identity server, said part of the network servers can perform a verification of the authentication of the identity owner by communicating or interacting with the hosting identity server or site. Here, the servers being adapted for performing said verification may comprise one or more identity servers and/or one or more merchant servers. Thus, the authenticated identity owner can be granted access to one or more sets of data stored or hosted at a server having performed said verification, said one or more sets of data having a corresponding access rule requiring such a verification. Here, the identity owner can be granted access to one or more sets of data of an identity hosted at an identity server or site having performed said verification. It is also within the present invention that the identity owner can be granted access to one or more sets of data stored or hosted at a merchant server upon said verification, such as a set of data comprising an account of the identity owner.

It should bee understood that the systems of the second aspect of the present invention may be combined with any if the systems of the first aspect of the present invention.

According to a third aspect of the present invention there is provide a system for managing individual identities of persons or other entities interacting on a network of clients and servers, said system comprising one or more name servers constituting a namespace and one or more identity servers

said identity servers managing individual identities of the persons or other entities by:

storing the identities, each identity comprising information data being stored in accordance with an information structure, the information relating to the person or entity in question, and

interacting with clients and/or servers in the network,

said name servers storing name strings and identity server addresses corresponding to each stored identity, said name servers thereby providing a mapping from the name strings to the corresponding identity servers, and

the interaction and the predetermined information structure allowing the clients and servers with which the identity servers interact to provide services towards users of the system, which services are specific to an identity regardless of which identity server is hosting that identity. Here, it is preferred that each identity has at least part of said information data being structured as a number of sets of data with at least part of said sets of data having one or more corresponding access rules selected from a plurality of different access rules. Here, it is preferred that said access rules of a given identity are being enforced by the identity server or site storing said given identity or by a server communicating with said identity server or site.

Also here it should be understood that the systems of the third aspect of the invention may be combined with any if the systems of the first or second aspect of the present invention.

According to a fourth aspect of the present invention there is presented a method of providing identity information to a user in a system for managing individual identities of persons or other entities, said system comprising one or more name servers constituting a namespace and one or more identity servers, said method comprising:

storing a number of identities in one or more of said identity servers, each identity representing identity information data of an individual person or entity, each identity having at least part of said information data being structured as a number of sets of data with at least part of said sets of data having one or more corresponding access rules selected from a plurality of different access rules,

storing name strings and identity server addresses corresponding to each stored identity in one or more of said name servers, said name servers thereby providing a mapping from the name strings to the corresponding identity servers, and

having a user requesting identity information from a stored identity of a selected person or entity by

forwarding via a client the name string of the selected person or entity into the namespace,

receiving from the namespace via said client the address of the identity server storing the identity of the selected person or entity,

forwarding via said client a request for identity information to the identity server storing the identity of the selected person or entity, said request asking for information of a selected set of data of the selected identity,

fulfilling at least one defined access rule corresponding to the selected set of data within the selected identity, and

receiving the requested information from the identity storing the selected identity server via said client.

Also in the fourth aspect of the invention it is preferred that said access rules of a given identity are being enforced by the identity server or site storing said given identity or by a server communicating with said identity server or site.

The method of the fourth aspect of the present invention may further include any of the systems according to the first aspect of the present invention.

According to a fifth aspect of the present invention there is presented a method of providing identity information to a user in a system for managing individual identities of persons or other entities, said system being selected from any of the systems of the first or second aspects of the invention comprising one or more name servers constituting a namespace and one or more identity servers, said method comprising

having a user requesting identity information from a stored identity of a selected person or entity by

forwarding via a client the name string of the selected person or entity into the namespace,

receiving from the namespace via said client the address of the identity server storing the identity of the selected person or entity,

forwarding via said client a request for identity information to the identity server storing the identity of the selected person or entity, said request asking for information of a selected set of data of the selected identity,

fulfilling at least one defined access rule corresponding to the selected set of data within the selected identity, and

receiving the requested information from the identity storing the selected identity server via said client.

For the methods of the fourth and/or fifth aspects of the invention it is preferred that the defined access rule comprises an authentication of a user to an access level or category of a so-called friend, said method further comprising:

having the requesting user authenticating himself towards an identity server storing an identity of the requesting user,

forwarding the request for the identity information to the identity server storing the identity of the selected person, while claiming being the owner of the identity of the requesting user,

having the identity server receiving said request performing a verification of the requesting user by having the identity server, which stores the identity of the requesting user, verifying that the requesting user has authenticated himself towards the requesting users identity server.

### BRIEF DESCRIPTION OF THE DRAWINGS

The foregoing and other objects, features, and advantages of the present invention will become more readily apparent upon reference to the following detailed description of preferred embodiments of the invention, when taken in conjunction with the accompanying drawings.

FIG. 1 shows a directory structure of the Domain Name System, DNS,

FIG. 2 shows a platform architecture of a system according to an embodiment of the present invention,

FIG. 3 shows an example of a personal identity according to the present invention,

FIG. 4 illustrates steps of communication performed according to an embodiment of the present invention when a first user having an identity stored at a first identity server wants information from an identity belonging to a second user and stored at a second identity server,

FIG. 5 illustrates steps of communication performed according to an embodiment of the present invention when a user having an identity stored at an identity server wants to login and exchange data with a merchant or other 3^{rd} party entities,

FIG. 6 illustrates steps of communication performed according to an embodiment of the present invention when a user having an identity stored at an identity server wants information from his own identity,

FIG. 7 illustrates steps of communication performed according to an embodiment of the present invention when a first user wants to communicate with a second user having an identity stored at an identity server, and

FIG. 8 illustrates steps of communication formed according to an embodiment of the present invention, when a merchant or other 3^{rd} party entity wishes to request information from an identity, either by previous agreement for access or upon granting such access now.

### DETAILED DESCRIPTION OF THE INVENTION

The individual identities according to the present invention are hosted by identity servers being part of an identity managing system. The identity managing system or identity system of the present invention can also encompass entities other than people, such as companies and other social groupings.

It should be understood that technology supporting an identity system platform of the present invention may undergo continuous evolutionary and revolutionary changes, and the system platform must evolve along with these developments. This applies in particular to the devices people will use to access the identities.

The obvious first client may be the web browser, and WAP and I-mode enabled mobile phones are also about to become a reality. Future generations of access devices will likely come with built-in support for identity.

From a technical viewpoint, the system platform may be based on generally accepted standards of the Internet community and the Internet Engineering Task Force (IETF).

Security may be an integral part of the system platform, employing strong cryptographic techniques and protocols (which may continually be strengthened as the technology evolves).

The identity may include a repository for various kinds of personal information, and it may be protected from unauthorised access.

The identity may also be used as a means of interaction between entities in the digital realm, and may form the basis for legally committing transactions and information transfer, financial and otherwise.

In practical use, the identity may be accessed from multiple mobile and stationary devices or clients situated at multiple locations. The strength of authentication may vary for different levels or classifications of the information of the identity, for different client devices and/or for different types of identities. The authentication may for example vary from a simple password typed at an anonymous PC with a browser, over a strong cryptographic protocol with hardware-token based private keys, to biometric identification. The level of access may be regulated accordingly, reflecting the risk of impersonation.

The identity system may be the underlying base for operating a global public-key infrastructure. Currently there are a number of more-or-less isolated attempts to establish public-key infrastructures. But the field is quite fragmented, and each new application typically needs yet another certificate.

The identity system may offer a natural way to unify this, by acting as a public-identification infrastructure, where people must be identified before they can be issued keys and begin to interact with others. With the identity platform users may only need to be identified in-person once.

The system of the present invention may be based around DNS, the Internet's Domain Name System. DNS is a fully distributed, scalable, and robust directory for looking up hierarchical names. As such, it may be an ideal foundation for the identity system.

Thus, each individual identity owned by a person or an entity may have a corresponding unique name string being a dot-separated hierarchical name within the DNS name-space, like aquafan.jens.hansen.dk, chosen to be unique and easy to remember for those who know Jens. This name string may be called a personal domain name, PDN.

The DNS may be ideal for many reasons:

It is the de-facto global name space for creating unique name strings.

The standard is non-commercial, being managed by the Internet community, and appropriate multilateral government organisations.

There are established rules for resolving disputes, such as name conflicts.

It is proven technology, having been an integral part of the Internet infra-structure for more than two decades.

It is distributed, with multiple redundant name servers, and thus very robust.

The name space is hierarchical, easily accommodating multi-billion names with a branching factor of only a few thousand at each level.

Every Internet Protocol (IP) based device on the Internet already knows the DNS protocol, so there is no need for a full upgrade cycle on the client access devices.

To be fair, there are also a couple of weaknesses in DNS: until recently it didn't support character sets beyond 7-bit US-ASCII (0-9; A-Z; -), and ownership of domain names are generally only regulated at the 2^{nd} level beyond the static top-level-domains.

Incidentally, it is very important that DNS is based on names and not on numbers, since we humans are much better at remembering and using name-based identification.

The present invention may allow for each person on the planet to be given a personal domain name, or PDN, and using it to gain access to identity-related services hosted on a number, which may be a large number, of identity servers throughout the Internet.

The PDN may function as: a universal address, as a universal account, and as a universal repository, reflecting the three categories of services, 1^{st}, 2^{nd} and 3^{rd} person, described above.

Each PDN may, by its presence in a DNS name server, provide access to an identity server hosting the identity information and services relating to the person owning-that PDN.

The PDN may act as a universal address by storing ‘low-level’ address such as telephone numbers and email address in the identity server. The user wishing to communicate with the owner of a PDN does not need to remember any of these low-level address, but need remember only one life-long address for that person. Domain names have an important property compared to telephone numbers and email addresses: the PDN is truly owned by the owner, whereas other addresses are typically ‘borrowed’ or ‘rented’ from the communications provider (you cannot keep your phone number if you relocate from Denmark to China, for instance). They are also global, so personal domain names can act as ‘telephone numbers’ for the Internet, which indeed is one of the applications of the present invention.

In a related function to the universal address, the PDN and the associated identity servers may act as an always-up-to-date directory entry for the owner. Whereas ‘dead’ directories, like a telephone book, invariably go out of date, the identity may be maintained directly by the owner, and may therefore always be current. Linking PDN-based identities can create an always-up-to-date address book that never needs synchronisation.

The PDN may act as a universal repository by storing at the identity server the personal information of the owner, which can then be accessed from any connected device, regardless of position. This includes items such as bookmarks, and can include very private information such as PIN codes, since access may be protected to ensure this information is only released to a properly authenticated owner.

Normally when visiting a service or site for the first time, it will ask the user to provide a large amount of personal data, like name, address, and so on. A simple alternative is to just provide the PDN, and have the site automatically query the identity server for the relevant information. If some of this information is not deemed public by the owner, he may be prompted whether to release this information to the site. In this way the PDN may function as a universal account name across multiple sites and services.

But the most far-reaching use of the PDN as a universal account name, may be where the owner by logging into the identity server also implicitly is authenticated towards a multitude of other sites and services on the net. These sites and services may interact with the identity servers to verify proper authentication of each user, and exchange transactional data. Having a single sign-on has been common on local-area-networks for a number of years, but the Internet is still in the earlier phase where the user has to explicitly log on to each services or site. The identity infra-structure of the present invention may provide a single sign-on to the Internet itself.

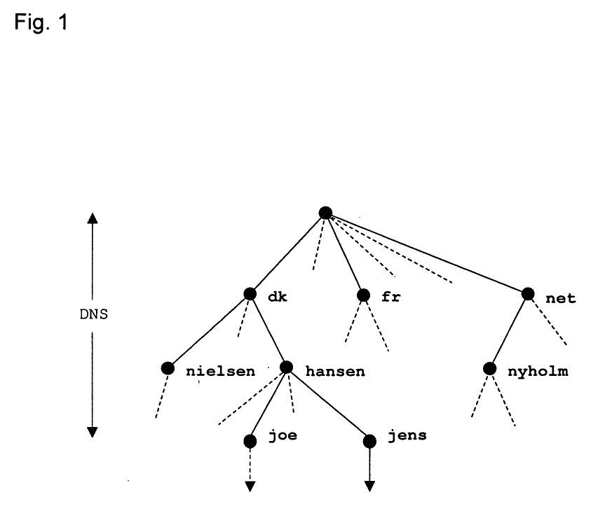

The directory structure of the Domain Name System, DNS, is illustrated in FIG. 1.

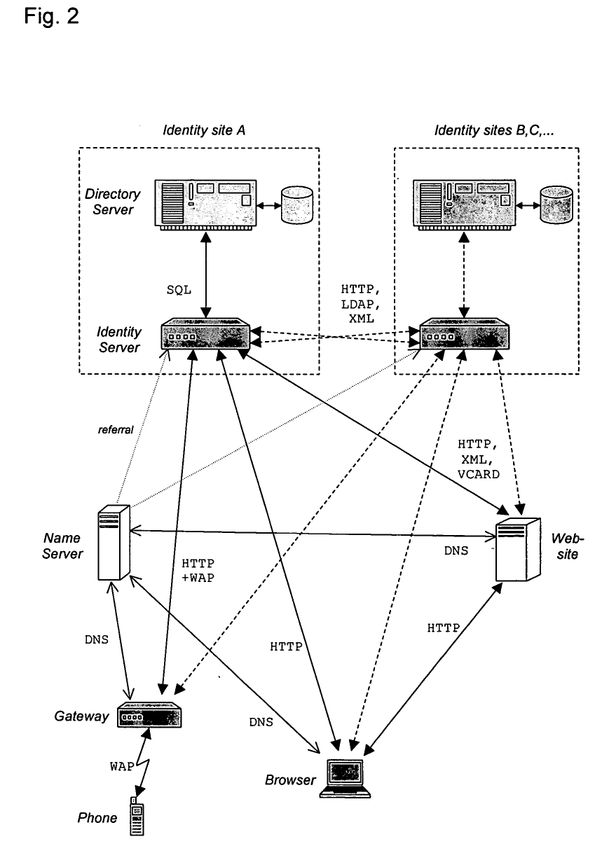

An architecture of a system according to an embodiment of the present invention, including the main components and communication paths of the system, is illustrated in FIG. 2.

The following components participate in the system of FIG. 2:

Identity sites. These are the distributed sites carrying an identity platform. Each identity site contains one or more of:

Identity servers. These are the access gateways to the directory information, and implement the various identity services and applications.

Directory servers. These are the back-end systems storing the identities or the identity information.

Name servers. These are the normal Internet name servers hosting DNS resource records, which link each PDN up with the appropriate identity server.

Browsers. Any client device running a standard web browser. The identity servers are accessed like any other web site.

Gateways. Facilitate special access networks, like wireless. It may be desirable to directly enable the identity servers for the various access protocols. For WAP, this enables end-to-end security from the phone into the identity site.

Web sites. Web sites that are enabled for the identity system can themselves interact directly with the identity servers, in order to facilitate identity-specific functionality. The fundamental service may be unified login across 3^{rd}-party sites. It may also include basic things like form filling, and may be developed into full support for automated e-payment, or other transactional data exchange.

In the system of FIG. 2, an identity server is shown as being part of an identity site, where the identity site further comprises a directory server for storing identities and/or identity information. However, as previously discussed, the term “identity server” may be used in the same meaning as the term “identity site”. Thus, an identity server may also include the means for storing the identity and/or the identity information, and the identity server may include the means for implementing the various identity services and applications, such as enforcing access rules.

The basic user experience when using the identity system may be that of visiting a web (or WAP) site specific to that particular person, the owner. It may display the white-pages-style information that the owner wishes to be publicly available, like email address, telephone number, etc.

The identity site may provide immediate links to the various ways of communicating with the owner, like email and voice-over-IP calls. This is the basic mode of operation for 2^{nd}-person functionality.

If the owner has a personal home page, the identity may also contain a link to this. The HTML content can be stored at any (free) host, using any more-or-less cryptic URL, and be accessed transparently from the identity.

The identity may be a kind of ‘master’ home page for the owner, and may derive its power from the structure of the data it provides. The data itself may be stored at the directory server or the identity server.

The identity site may allow the owner to authenticate him- or herself in various ways, thereby gaining access to the private information of the identity, that is, the 1^{st}-person features. This is also how the owner manages the identity information, authorizes applicable 3^{rd}-party access, et cetera.

Finally, the identity site may support various protocols for interacting with enabled 3^{rd}-party web sites. This may form the basis for 3^{rd}-person functionality.

The security of the identities may be founded on public-key certificates, in particular X.509. They are issued in the normal fashion by current and future certificate authorities, and the normal issues with root-key installation and certificate revocation apply. Each person may have one main certificate called the public identity certificate, PIC.

In addition to the typical contents of a certificate (name, public key, et cetera), the public identity certificate contains the PDN, and the issuing certificate authority must verify that the person in question is the proper owner of that DNS name. This is how the public key infrastructure may be built on top of the public identity infrastructure.

Each owner of a PDN may need a corresponding PIC to reap the full benefit of the identity platform. The PIC may be considered an integral part of the identity, and be issued along with the registration of the PDN.

The owner may now issue signed attribute certificates, authorising transactions and granting various access-rights to selected 3^{rd}-parties, like e-commerce sites. The signatures can be verified by the 3^{rd}-party using the public identity certificate.

Attribute certificates may also be issued and signed by 3^{rd} parties. In this case it is the 3^{rd} party that makes a statement of authorization towards the identified user. This resembles the PIC, which is also signed by a 3^{rd} party, namely the certificate authority.

Both issuance (signing) and reception (verification) of attribute certificates can be done without involving the certificate authority (except possibly for revocation checking). This greatly streamlines the use of certificates, since interaction with certificate authorities tend to be high in procedural overhead.

The identity system of the present invention may provide a variety of business opportunities for the players that operate and maintain it:

Registering and hosting PDNs: this is akin to the well-known domain-name business.

Hosting directory info: the identity information needs to be hosted in a reliable fashion, possibly on a subscription basis.

Identity services and applications: possibly operated in tandem with directory

hosting; this is decisive for the functionality and end-user experience.

Certificate authority: issuing the public identity certificates on which the security rests, including procedures for one-time in-person authentication.

Additionally, the identity system allows 3^{rd}-party sites and services to enhance and improve their functionality and end-user experience. Thereby they can increase their competitiveness and end-user loyalty.

Identity Account Management

In order to use an identity system according to the present invention, the user should establish an identity by creating an identity server account with a host provider.

Enrolment. A digital identity may be established using the following steps:

1. Select and register a name string within the global name space.

2. Create an identity server account with a host provider

3. Make the name servers map the chosen name string to the address of the identity server.

4. The owner logs into the identity, and enters the desired data, access rights, etc.

Example: The user registers hans.hurvig.dk within DNS, and creates an identity account with the company DIHost, whose identity server(s) is at the web address is.dihost.dk. The user then goes to his DNS host and sets up the necessary DNS records mapping hans.hurvig.dk to the Internet Protocol (IP) address of is.dihost.dk. The user can now directly access the identity account. Upon doing this for the first time, the identity server may ask the user to choose a password, or alternatively prove that he has the right to use the account, for instance by referring to an earlier authentication number provided when the account was created. Subsequent to this, the identity account can be used in the normal fashion, and the typical first task for the user is to start entering identity data and setting up the access controls.

Re-hosting. An identity can be moved from one identity server to another using the following steps:

1: Create an identity account with a new host provider.

2: Take a snap-shot of the data (items, etc) stored in the identity at the old host provider.

3: Copy this snap-shot to the identity at the new host provider.

4: Change the name servers mapping for the (unchanged) name string to the address of the new identity server.

Note that this is transparent to all users of the identity, since the name string (hans.hurvig.dk) remains unchanged. It is only the mapped-to address that changes, and that is only handled by the client device, which is typically a www browser that does the DNS lookup transparently.

Of course, there is rarely any reason to actually re-host an identity account. When the owner changes telephone, email, or even move physically, etc, the identity may simply be updated with the new data.

Identity

A number of structured data sets describing an identity may be organised into a collection of ‘items’. Each item may include a ‘type’, a ‘value’, and an ‘access category’, in addition to any other fields that may be appropriate. The items may be represented in an SQL data base or other directory, as an XML structure, or any similar format.

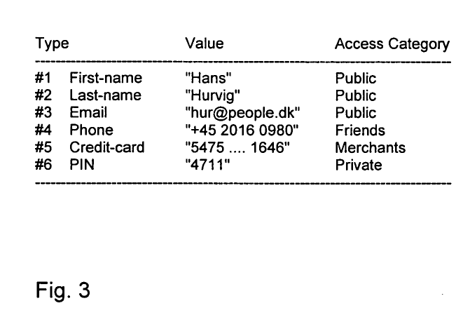

FIG. 3 shows an example on an identity for a person or entity having the name string hans.hurvig.dk. This identity has 6 sets of data or items, each item having a type, a value and an access category.

An access category may consist of a collection of Personal Domian Names or URLs defining the identity owners and server sites that may be granted access to the information of the item in question. Table 1 lists the access categories of the identity of FIG. 3 together with examples of persons or entities being allowed access within each listed category.

TABLE I

| | |
|---|---|
| Public | (special category, includes everybody) |
| Friends | (includes identities listed by the identity owner as friends) |
| james.derry.uk | |
| nina.hurvig.dk | |
| Merchants | (includes merchant server sites and other 3^{rd} parties listed by the |
| | identity owner) |
| www.amazon.com | |
| www.myfinancials.com | |
| Private | (special category, includes the owner of the identity) |

The identity of FIG. 3 contains the following 6 items: a first and last name which is publicly available, an email address which is also publicly available, a phone number which available to other identities that have been designated as friends, a credit-card number which is only available to designated and properly authenticated merchants, and a PIN code which is only available to the identity owner himself.

Any unauthenticated client or server that requests information from this identity will be given (only) items #1, #2, and #3.

In the example of FIG. 3 identities categorised as friends can get access to item #4 given the following conditions:

the friend has his own identity, hosted on the same or a different identity server,

the friend in question is currently authenticated towards the identity server hosting his identity,

the friend's PDN is explicitly included in the access category Friends.

Selected server sites can get access to item #5 given the following conditions:

the site is able to authenticate itself, for instance by means of a certificate in connection with the SSL (Secure Socket Layer) protocol,

the site's URL is explicitly included in the access category Merchants.

Item #6 is only made available to the owner of the identity, where the owner is able to authenticate himself towards the identity on the server (by means of a password, a smartcard, or something similar). It requires the same kind of owner authentication to update the items of the identity, change their access categories, manipulate the contents of the access categories themselves, etc.

Identity Information Management

When a user has created an identity account and stored an identity at an identity server, information may be obtained from this stored identity, by the identity holder himself, by other identities or by 3^{rd} party entities.

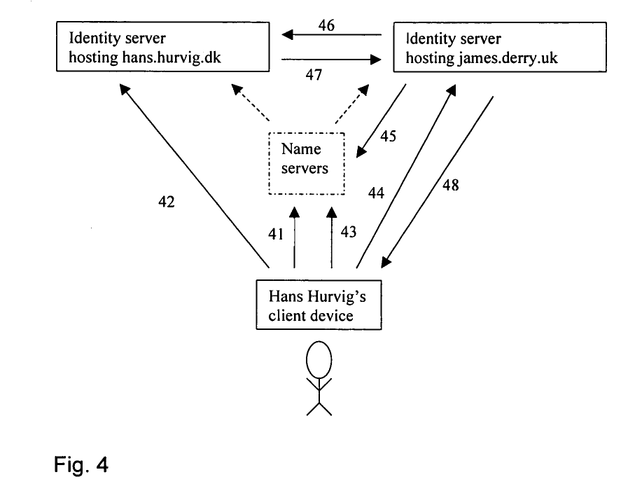

An example is shown in FIG. 4, which illustrates steps of communication performed according to an embodiment of the present invention, when a first user having an identity stored at a first identity server wants information from an identity belonging to a second user and stored at a second identity server.

The two identities have the name strings: james.derry.uk and hans.hurvig.dk. James considers Hans his friend, and allows him access to his telephone number. James's identity server cannot itself authenticate Hans, being the person accessing the identity james.derry.uk by an arbitrary client device. Instead, the identity server hosting the identity of james.derry.uk, must query the identity server hosting the identity of hans.hurvig.dk to authenticate Hans.

This is only possible if Hans has already authenticated himself at the identity server hosting the identity of hans.hurvig.dk, and thereby attaining a unique and/or unpredictable token, which is then used to authenticate him when accessing the identity of james.derry.uk.

The following steps describes how Hans, being the person accessing other identities by an arbitrary Internet Protocol (IP) enabled client device, may get access to the identity of james.derry.uk. The client device may, for example, be a personal computer installed with browser software for accessing data over the HTTP protocol, commonly deemed as a Web Browser.

41. Hans must log into his own identity server, and types (or may input through other means) the name string of his own identity—hans.hurvig.dk. The client device queries the name servers for the Internet Protocol (IP) address of the identity server hosting the identity of hans.hurvig.dk. The name servers return—in accordance with the DNS specification—an IP string being the host address of the identity server hosting the identity corresponding to the name string hans.hurvig.dk.

42. The client device sends a request to the hosting identity server using the obtained host address, and the hosting server is, for the sake of this example, returning IP packets, in total comprising an HTML formatted page with embedded elements, such as graphics and text.

Hans must authenticate himself to the hosting identity server by providing a secret key such as a password or by other means like using a smart card. The identity server verifies the correctness of the supplied secret key, and, in this example, returns to the client device a new key or a unique token that may be stored by the client device, for a determined time.

43. Hans wants to access James' identity. He inputs the string james.derry.uk, which is translated by the name servers into an IP address of the identity server hosting the identity corresponding to james.derry.uk as described above.

44. Hans' client device accesses the identity server of james.derry.uk and forward the obtained new key or token, or a token derived from the obtained new key or token, to James' identity server, while Hans presents himself to the identity server of james.derry.uk as being the physical person behind the identity hans.hurvig.dk.

45. James' identity server checks from James' identity data that he considers hans.hurvig.dk a friend. If this is indeed so, it asks the name servers for the address of the identity server of hans.hurvig.dk.

46. James' identity server passes on the request of identification to the identity server of hans.hurvig.dk together with the received new key or token, or the received derived token.

47. Hans' identity is verified at the identity server hosting hans.hurvig.dk by checking the derived token or the obtained new key or token previously released to the client device. A positive or negative confirmation is sent back to the identity server of james.derry.uk.

48. Now James's identity server knows that (1) Hans is a friend of James, and (2) that the person making the request is really Hans.

If the access category of the telephone number item has been granted as available to friends, the information item is returned to the client device.

The exact same thing may happen if Hans wants to access an account at a digital-identity enabled merchant or other 3^{rd} party. Here the merchant server takes the place of James's identity server. When Hans wants to access his account in step 44, the merchant server likewise queries the identity server for hans.hurvig.dk, and lets that identity server verify the authenticity of the person claiming to be hans.hurvig.dk.

So the trust relationship may go like this: the merchant server, or James's identity-server, trusts the identity server for hans.hurvig.dk to verify the authenticity of the person Hans Hurvig. It should be understood that the verification of the authentication of the person Hans Hurvig may be obtained by other means than issuing and forwarding a new key or token, which is valid for a determined time.

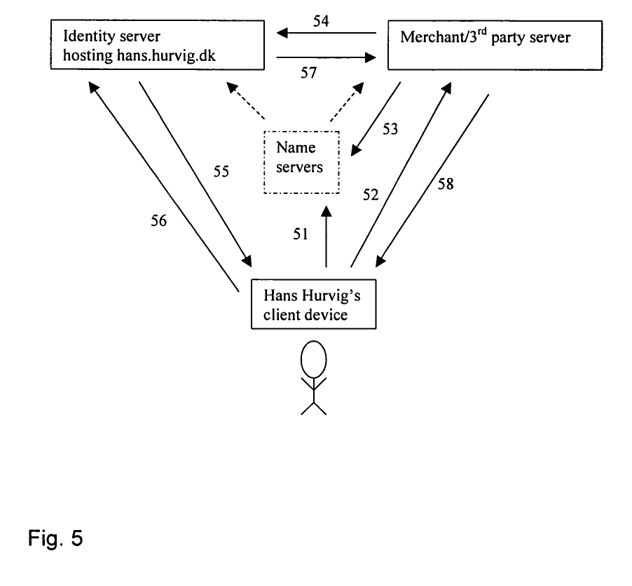

FIG. 5 illustrates steps of communication performed according to an embodiment of the present invention when a user having an identity stored at an identity server, wants to login and exchange data with a merchant or other 3^{rd} party entity.

In this example, the trust relationship goes the other way: when Hans's identity server needs to trust the authenticity of a merchant server before allowing the merchant server to access any information item.

For the purpose of example, the third party is the merchant amazoom.com, and the data exchanged is credit card information of Hans. Access is via a Web Browser, as described in the script for FIG. 4.

The following steps are illustrated in FIG. 5:

51. Hans wants to access the merchant. His client device asks the name servers for the address of the merchant, say www.amazoom.com. The name servers return the associated IP address record.

52. Hans accesses the merchant. Upon checkout of the order, Hans provides his identity name string, hans.hurvig.dk.

53. The merchant wants to access the credit card information item from Hans' identity server, and queries the name servers for the address of the identity server for hans.hurvig.dk. The name servers return the associated IP address record.

54. The merchant queries the identity server for the information, and also provides proof that it really is www.amazoom.com, for example by means of an X509 certificate and using the SSL protocol. Hans's identity server checks the merchant server site credentials, and verifies that Hans has indeed designated the required items (address, credit-card number, etc) as being accessible to-this merchant server site:

55. If Hans hasn't granted permanent access to any of the items, the system may optionally ask Hans whether he wants to grant this access, possibly in a time/use limited manner. Alternatively, it may reject the request and simply deny the merchant access to the requested information item.

56. Hans' client device is contacted to let Hans decides whether he does in fact wish to allow this particular merchant site access to the requested items. His choice is returned to his identity server.

57. If the access is granted, the identity server returns the requested information items to the merchant server.

58. The merchant can complete the order with the acquired information items.

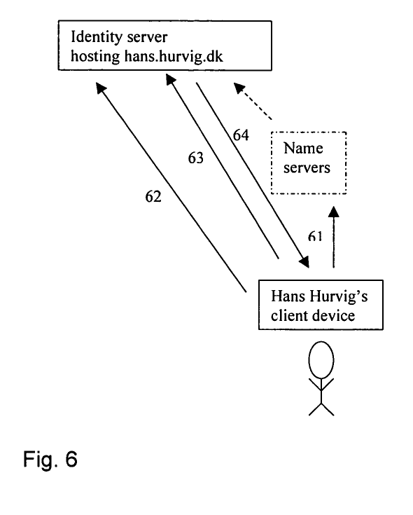

FIG. 6 are illustrated steps of communication, performed according to an embodiment of the present invention, of a user, having an identity stored at an identity server, accessing information from his own identity.

These information items may be accessed either through a data view, or may be accessed dynamically through an external application, such as a calendar, telephony application, and communication applications. For the purpose of this example, we assume that access is via a Web Browser, as described in the script for FIG. 4.

61. Hans wants to log into his identity server. His client device queries the name servers for the address of hans.hurvig.dk. The name servers return the associated IP address record.

62. Hans must authenticate himself to the identity server, by providing a secret key such as a password or by other means like using a smart card.

The identity server verifies the correctness of the supplied secret key and returns to the client device a new key or unique token that is stored by the client device for a determined time.

63. Hans requests, from the same session and client device, access to his private data, such as a PIN code. During this request, the received new key or token, or a token derived from the received new key or token, is forwarded to the identity server.

64. The identity server verifies by checking the received new key or token, or by checking the derived token, that the request comes from a properly authenticated client device, and delivers the information: The identity server may enforce various restrictions, such as only accepting certain (types on client devices, or allowing a maximum time limit since the owner was authenticated.

Note that items categorised as private are never handed out to any requester, except in this scenario, where the requestor is explicitly authenticated as being the owner. Requests from unauthenticated clients or from merchant servers of other identity servers for this type of item will be rejected unconditionally.

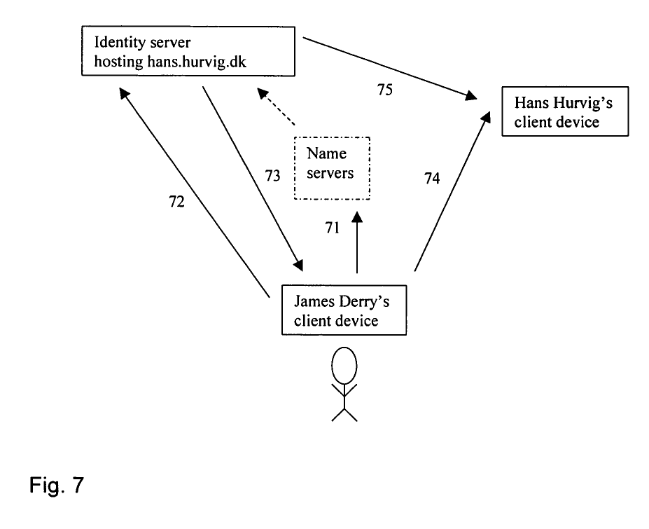

FIG. 7 illustrates steps of communication performed according to an embodiment of the present invention when a first user wants to communicate with a second user having an identity stored at an identity server. Here, the identity may be considered a “universal address”, where, as an example, the name string may be used both for emailing and for telephoning with a properly enabled access device. Here, the identity server may act as a communications manager, either by redirecting or by forwarding communication.

The following steps are illustrated in FIG. 7:

71. James wants to communicate with Hans, but doesn't remember his email address or his telephone number (both of which are publicly available in this example). He does however remember Hans's PDN.

The client access device queries the name servers for the identity server hosting Hans's identity, hans.hurvig.dk. The name servers return the associated IP address record.

72. The client access device asks the identity server for the relevant item that contains Hans's address for the given mode of communication, say telephone or email.

73. The identity server provides the relevant ‘physical’ address, such as a telephone number or the address where Hans's (incoming) email is stored.

74. The client device, can now establish contact with Hans (or his client device). This is the scenario where the identity server acts as a “communications redirector”.

Alternatively the identity server can act as a “communications gateway” as follows:

71. Like before.

72. James starts the communication directly with the identity server; if it is by email he sends the mail message to the identity server, if by phone he ‘dials’ the identity server. 73+74. (skipped)

75. The identity server now forwards the message directly to Hans's client device. It may also accept returning communications from Hans back to James.

This can of course be generalised to any form of communication, each with its own format of ‘physical’ addresses, where the PDN acts as a universal ‘logical’ address, which people may have to remember.

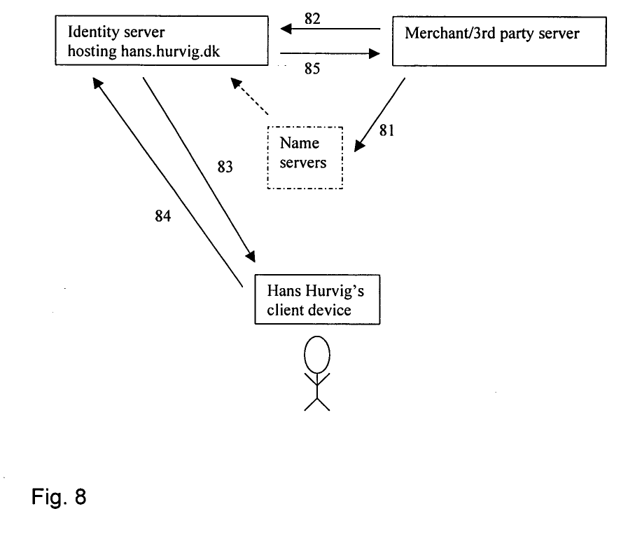

FIG. 8 illustrates steps of communication formed according to an embodiment of the present invention, when a merchant or other 3^{rd} party entity wishes to request information from an identity, either by previous agreement for access or upon granting such access now.

The purpose of this example is to display the possibility of attaining access to information records in an asynchronous communication mode.

For the purpose of example, the third party is the merchant amazoom.com, and the data exchanged is credit card information of Hans. Access is via a Web Browser, as described in the script for FIG. 4.

81. The merchant wishes to access the credit card information item from Hans' identity server, in order to bill Hans for the yearly subscription. The merchant queries the name servers for the address of the identity server for hans.hurvig.dk. The name servers return the associated IP address record.

82. The merchant queries the identity server for the information, and also provides proof that it really is www.amazoom.com, for example by means of an X509 certificate and using the SSL protocol. Hans's identity server checks the merchant server site credentials, and verifies that Hans has indeed designated the required items (address, credit-card number, etc) as being accessible to this merchant server site.

83. If Hans hasn't granted permanent access to any of the items, the system may optionally ask Hans whether he wants to grant this access, possibly in a time/use limited manner.

84. Hans' client device is contacted to let Hans decide whether he does in fact wish to allow this particular merchant site access to the requested items. His choice is returned to his identity server.

85. If the access is granted, the identity server returns the requested information items to the merchant server.

While the invention has been particularly shown and described with reference to particular embodiments, it will be understood by those skilled in the art that various changes in form and details may be made therein without departing from the spirit and scope of the invention, and it is intended that such changes come within the scope of the following claims.

1: A system for managing individual identities of persons or other entities interacting on a network of clients and servers, said system comprising one or more name servers constituting a namespace and one or more identity servers,
said identity servers storing a number of identities, each identity representing identity information data of an individual person or entity, each identity having at least part of said information data being structured as a number of sets of data with at least part of said sets of data having one or more corresponding access rules selected from a plurality of different access rules, said access rules of a given identity being enforced by the identity server storing said given identity, and
said name servers storing name strings and identity server addresses corresponding to each stored identity, said name servers thereby providing a mapping from the name strings to the corresponding identity servers.

2: A system according to claim 1, wherein the access rules are selected from a plurality of at least two, such as at least three or such as at least four different access rules.

3: A system according to claim 1, wherein an identity comprises at least two sets of data, and wherein one of said sets of data has at least one corresponding access rule being different to the corresponding access rule(s) of the other sets of data.

4: A system according to claim 3, wherein the data structure of an identity comprises at least three sets of data, and wherein each of two of said sets of data has at least one corresponding access rule being different to the corresponding access rule(s) of the other sets of data.

5: A system according to claim 1, wherein the plurality of access rules comprises access rules representing different levels or categories of authentication of a person, an entity and/or server site requesting access to a set of data of a stored identity.

6: A system according to claim 1, wherein an access rule is given or identified by an access category.

7: A system according to claim 6, wherein an access category represents one of the categories: public, friend, merchant and/or private.

8: A system according to claim 1, wherein an identity comprises a set of data having a corresponding access rule holding information of a selected number of persons, entities and/or server sites being allowed access via said access rule to the information of said set of data.

9: A system according to claim 8, wherein said persons, entities and/or server sites being allowed access are represented by corresponding Personal Domain Names, PDNs, and/or Uniform Resource Locators, URLs.

10: A system according to claim 1, wherein at least part or all of the sets of data are items.

11: A system according to claim 1, wherein the sets of data or items are represented in an SQL database.

12: A system according to claim 11, wherein the sets of data or items are represented as an XML structure.

13: A system according to claim 6, wherein an access category is organised in an access category field of the corresponding set of data or item.

14: A system according to claim 1, wherein the identity information data of a set of data or an item is organised in a type field and/or a value field.

15: A system according to claim 1, wherein the system comprises a plurality of identity servers.

16: A system according to claim 1, wherein the plurality of different access rules comprises an access rule allowing an identity server to grant any non-authenticated person and/or entity access to a corresponding set of data.

17: A system according to claim 1, wherein the plurality of different access rules comprises one or more access rules allowing an identity server to grant only persons and/or entities being authenticated according to a defined authentication process access to the set(s) of data corresponding to the access rule(s).

18: A system according to claim 17, wherein an identity server hosting a stored identity having a so-called private set of data is adapted to only grant access to said private set of data to the owner of said stored identity upon authentication of the owner towards the hosting identity server.

19: A system according to claim 18, wherein said authentication is performed via a client device, said client device thereby being granted access to the private set of data.

20: A system according to claim 19, wherein the client device is granted access to the private set of data within a limited time after the authentication.

21: A system according to claim 15, wherein at least part of the network servers are adapted to communicate or interact with an identity server storing an identity having an owner, so that when the owner of the stored identity has been authenticated towards the hosting identity server, said part of the network servers can perform a verification of the authentication of the identity owner by communicating or interacting with the hosting identity server.

22: A system according to claim 21, wherein said servers being adapted for performing said verification comprises one or more identity servers and/or one or more merchant servers.

23: A system according to claim 21, wherein said identity owner can be granted access to one or more sets of data stored or hosted at a server having performed said verification.

24: A system according to claim 23, wherein said identity owner can be granted access to one or more sets of data of an identity hosted at an identity server having performed said verification.

25: A system according to claim 22, wherein the identity owner can be granted access to one or more sets of data stored or hosted at a merchant server upon said verification.

26: A system according to claim 25, wherein the identity owner can be granted access to a set of data comprising an account of the identity owner.

27: A system according to claim 17, wherein one or more network servers are adapted to be authenticated towards an identity server hosting an identity, said servers thereby being granted access to one or more sets of data of said identity, said set(s) of data having access rules being fulfilled by said authentication.

28: A system according to claim 1, wherein a network server is adapted to be authenticated towards an identity server hosting one or more identities, and wherein said network server when being authenticated may request access to information from an identity having an owner and stored at said hosting identity server, which information has not yet being given an access rule allowing access to the authenticated server, said hosting identity server being adapted to forward a request to the identity owner to temporarily or permanently grant access to the information to the authenticated server.

29: A system according to claim 28, wherein the request for granting access to the authenticated server is forwarded to a client device being used by the identity owner.

30: A system according to claim 29, wherein the identity owner is authenticated towards said hosting identity server via said client device.

31: A system according to claim 27, wherein a network server is a merchant server authenticating itself towards the hosting identity server by means of an X509 certificate and using a SSL protocol.

32: A system according to claim 1, wherein a communication from a client device or server to an identity server storing a given identity is established by forwarding the name string of the given identity from the client device or server into the namespace, said name string being received by a name server hosting said name string and hosting the address of the identity server storing the given identity, said identity server address being forwarded via the hosting name server to said client device or server wishing to communicate with the identity server storing the given identity.

33: A system according to claim 1, wherein an identity server is adapted to forward one or more sets of data of a stored identity to a client device or server being granted access to said one or more sets of data.

34: A system according to claim 1, wherein an identity server storing an identity is adapted to receive a message to the owner of the stored identity and to forward said message to a client device or server being used by the identity owner.

35: A system according to claim 1, wherein the owner of a stored identity is allowed to change the information of said identity or to store information at said identity upon authentication of the owner towards the hosting identity server.

36: A system according to claim 35, wherein said authentication is performed via a client device, said client device thereby being granted access to the identity of the owner.

37: A system according to claim 36, wherein the client device is granted access to the owned identity within a limited time after the authentication.

38: A system according to claim 1, wherein the name servers function according to the Domain Name System, DNS, of the Internet.

39: A system according to claim 1, wherein a name string is a personal domain name, PDN, reserved within the Domain Name System, DNS, so as to make it distinguishable from all other name strings reserved within the Domain Name System.

40: A system according to claim 1, wherein the plurality of access rules includes an access rule being at least partly fulfilled by an authentication process comprising the provision of a password.

41: A system according to claim 1, wherein the plurality of access rules includes an access rule being at least partly fulfilled by an authentication process comprising the provision of a smart card.

42: A system according to claim 1, wherein an authentication of an identity owner towards a server hosting the owned identity is performed in relation to the corresponding name string of the identity.

43: A system according to claim 1, wherein the access rules of a given identity are specified by the owner of said given identity.

44: A system according to claim 1, wherein the amount of identity information of a given identity being accessible via a corresponding access rule is specified by the owner of said given identity.

45: A system according to claim 1, wherein access to information or sets of data of a stored identity can be requested from all or at least part of the client devices of the network.

46: A system according to claim 1, wherein access to information or sets of data of a stored identity can be requested from all or at least part of the servers or server devices of the network.

47: A system according to claim 1, wherein when the owner of an identity has been authenticated towards the hosting identity server, the hosting identity server forwards a token for later verification to the client device from which the owner is communicating with the hosting identity server.

48: A system according to claim 47, wherein said verification token or a token derived from said verification token may be forwarded from the owners client device to other identity servers or network servers, whereby said other identity servers or network servers may use the obtained verification token or derived token for having the hosting identity server verifying that the owner has been properly authenticated.

49: A system according to claim 47, wherein said verification token and/or derived token has the form of a unique and/or unpredictable number or bit string.

50: A system according to claim 1, wherein the identity servers are managed on a corporate, sub-national, national or regional level, and inter-operated by means of common protocols.

51: A system according to claim 1, wherein the network of clients or servers is a national, a regional or a global network.

52: A system according to claim 1, wherein the name string acts as a global address.

53: A system according to claim 1, wherein an identity representing data of an owner is established by:
registering a name string of the owner within the name space,
creating an identity server account with a host provider, whereby an identity corresponding to the name string of the owner is obtained at a hosting identity server,
making the name servers map the registered name string to the address of the identity server hosting the identity of the owner, and
having the owner logging into the identity and entering sets of data and/or access rights or rules.

54: A system for managing individual identities of persons or other entities interacting on a network of clients and servers, said system comprising one or more name servers constituting a namespace and one or more identity servers
said identity servers managing individual identities of the persons or other entities by:
storing the identities, each identity comprising information data being stored in accordance with an information structure, the information relating to the person or entity in question, and
interacting with clients and/or servers in the network,
said name servers storing name strings and identity server addresses corresponding to each stored identity, said name servers thereby providing a mapping from the name strings to the corresponding identity servers, and
the interaction and the predetermined information structure allowing the clients and servers with which the identity servers interact to provide services towards users of the system, which services are specific to an identity regardless of which identity server is hosting that identity.

55: A system according to claim 54, wherein each identity has at least part of said information data being structured as a number of sets of data with at least part of said sets of data having one or more corresponding access rules selected from a plurality of different access rules, said access rules of a given identity being enforced by the identity server storing said given identity.

56: A method of providing identity information to a user in a system for managing individual identities of persons or other entities, said system comprising one or more name servers constituting a namespace and one or more identity servers, said method comprising:
storing a number of identities in one or more of said identity servers, each identity representing identity information data of an individual person or entity, each identity having at least part of said information data being structured as a number of sets of data with at least part of said sets of data having one or more corresponding access rules selected from a plurality of different access rules, said access rules of a given identity being enforced by the identity server storing said given identity,
storing name strings and identity server addresses corresponding to each stored identity in one or more of said name servers, said name servers thereby providing a mapping from the name strings to the corresponding identity servers, and
having a user requesting identity information from a stored identity of a selected person or entity by
forwarding via a client the name string of the selected person or entity into the namespace,
receiving from the namespace via said client the address of the identity server storing the identity of the selected person or entity,
forwarding via said client a request for identity information to the identity server storing the identity of the selected person or entity, said request asking for information of a selected set of data of the selected identity,
fulfilling at least one defined access rule corresponding to the selected set of data within the selected identity, and receiving the requested information from the identity storing the selected identity server via said client.

57: A method of providing identity information to a user in a system for managing individual identities of persons or other entities, said system being selected from the systems of claim 1, said method comprising:
having a user requesting identity information from a stored identity of a selected person or entity by
forwarding via a client the name string of the selected person or entity into the namespace,
receiving from the namespace via said client the address of the identity server storing the identity of the selected person or entity,
forwarding via said client a request for identity information to the identity server storing the identity of the selected person or entity, said request asking for information of a selected set of data of the selected identity,
fulfilling at least one defined access rule corresponding to the selected set of data within the selected identity, and receiving the requested information from the identity storing the selected identity server via said client.

58: A method according to claim 56, wherein the defined access rule comprises an authentication of a user to an access level or category of a so-called friend, said method further comprising:
having the requesting user authenticating himself towards an identity server storing an identity of the requesting user,
forwarding the request for the identity information to the identity server storing the identity of the selected person, while claiming being the owner of the identity of the requesting user,
having the identity server receiving said request performing a verification of the requesting user by having the identity server, which stores the identity of the requesting user, verifying that the requesting user has authenticated himself towards the requesting users identity server.
